(19) United States
(12) Patent Application Publication
(10) Pub. No.: US 2005/0074025 A1
(43) Pub. Date: Apr. 7, 2005

(54) Media Access Control Protocol for wireless sensor networks

(76) Inventors: Huai-Rong Shao, Cambridge, MA (US); Mehmet-Can Vuran, Atlanta, CA (US); Chia Shen, Lexington, MA (US)

Correspondence Address: Patent Department;Mitsubishi Electric Research Laboratories, Inc., 201 Broadway, Cambridge, MA, 02139, US

(21) Appl. No.: 10/677,518

(22) Filed: Oct. 2, 2003

(51) Int. Cl. H04L 12/43; H04J 3/24; H04J 3/16

(52) U.S. Cl. 370/461; 370/473; 370/469

(57) ABSTRACT

A media access control protocol for a network including sensor nodes connected to each by a single shared wireless communications channel executes the following protocol in each node so that network access is managed in a distributed manner. The node monitors the channel for a period of time equal to at least a length of a frame. A frame length is predetermined and depends on network conditions. The frame is partitioned into time slots. A particular time slot is marked as occupied if the channel has a carrier signal during the time slot and otherwise the time slot is marked as available. The node only transmits a packet during available time slots. The frame structure is updated on a periodic basis if a configuration of the network changes over time.

### FIELD OF THE INVENTION

This invention relates generally to wireless sensor networks, and more particularly to media access control protocols for such networks.

### BACKGROUND OF THE INVENTION

Wireless sensor networks (WSN) enable computers to sense and interact with real world phenomena. WSN have been used for environmental monitoring, biomedical research, human imaging and tracking, and industrial and military applications.

In a WSN, each node is equipped with one or more sensors. The sensors acquire data that are usually transmitted to a centralized processor via a single shared wireless channel. This makes the design of a medium access control (MAC) layer very important. Because the nodes are typically battery operated, one important performance metric in a WSN is energy consumption. Other performance metrics are throughput and latency.

WSN applications can be characterized according to the mode used to acquire and transmit data. For example, weather sensors acquire data on a continuous basis, while alarm sensors are event based. These different characteristics pose different challenges to the MAC layer, particular when a sensor node acquires data in both modes.

Typically, two types of access protocols are mainly used in WSN: time division multiple access (TDMA), and carrier sense multiple access (CSMA). TDMA protocols have the advantage of collision-free communication because each node transmits data during a predetermined time interval. However, TDMA protocols require coordination of the assigned time intervals. Typically, this requires some type of infrastructure, which is not suitable for an ad-hoc or dynamic WSN. CSMA protocols do not require any infrastructure. However, the probability of collision increases with node density. Collisions increase energy consumption and decrease throughput.

The distributed control function (DCF) of the IEEE 802.11b standard, IEEE 802.11, “Wireless LAN medium access control (MAC) and physical layer (phy) specifications,” 1999, is a contention-based protocol with four-way (RTS/CTS/DATA/ACK) handshaking. Each node contends for the medium by first monitoring the channel and initiates communication with a receiver only when the channel is available. Monitoring the channel consumes energy. Also, collisions are more likely as the density of the network increases.

A sensor MAC (S-MAC) protocol decreases energy consumption for throughput and latency by using periodic sleep periods at each node. Nodes within transmission range of each other synchronize themselves according to the sleep periods. Although energy consumption is decreased, the collision probability increases during the shorter time intervals nodes are allowed to transmit. In addition, fixed sleep periods are not suited for event-based sensors, see Ye et al., “An Energy Efficient MAC Protocol for Wireless Sensor Networks,” Proc. INFOCOM'02, June 2002.

An energy-aware TDMA-based MAC protocol can be composed of clusters and gateways. Each gateway acts as a cluster-based centralized network manager and assigns slots in a TDMA frame based on transmission requirements of the nodes, see Arisha et al., “Energy-aware TDMA-based MAC for sensor networks,” to appear in Journal of Computer Networks.

The IEEE 802.15.4 standard can also be used for low data rate wireless sensor networks. That standard uses a superframe structure with two disjoint periods, i.e., a contention access period and contention free period. The network is assumed to be clustered and each cluster header broadcasts a frame structure and allocates time intervals to prioritized traffic in the contention free period. During the contention period, nodes use CSMA/CA to access the channel.

A rate control method can also regulate media access. However, that solution is inapplicable for high density WSN with a low data rate, see Woo et al., “A transmission control scheme for media access in sensor networks,” Proc. ACM Mobicom '01, July 2001.

Another collision-free MAC protocol is based on a time-slotted structure, see Rajendran et al., “Energy-Efficient, Collision-Free Medium Access Control for Wireless Sensor Networks,” Proc. ACM SenSys 03, November 2003. That system uses a distributed selection scheme based on traffic requirements of each node to determine the time slot that a node should use for transmissions. Each node acquires information about every two-hop neighbor and the traffic information of each node during a random access period. Based on this information, each node determines a priority and decides on which time slot to use. Nodes without any packets to send or receive sleep for the specific time slot. Although the protocol has a high delivery ratio with tolerable delay, the performance of the protocol depends on the two-hop neighborhood information in each node. Because this information is collected through signaling, the energy consumption increases significantly in the case of a high density network. This can also cause incomplete neighbor information due to collisions.

### SUMMARY OF THE INVENTION

Wireless sensor networks (WSN) are characterized by low energy consumption and distributed networking requirements. The invention is suited for a high density WSN where nodes periodically transmit or receive data. The invention uses a distributed frame structure. This structure provides coordination for sensor nodes without an infrastructure.

The distributed frame-based MAC protocol (DFB-MAC) combines the robustness and distributed nature of contention-based protocols with high throughput and energy efficiency of frame-based protocols.

Nodes determine when to packets can be transmitted by passively monitoring the channel. The monitoring reveals available time slots and time slots that are occupied by other nodes. The invention does not require any sharing of scheduling information among the nodes.

The DFB-MAC according to the invention achieves significant energy savings when compared to IEEE 802.11b distributed control function (DCF), a typical prior art distributed MAC protocol used in sensor networks.

The DFB-MAC not only decreases energy consumption but also provides higher efficiency by using intelligent scheduling. The DFB-MAC has acceptable latency performance making it suitable for a high density WSN.

### BRIEF DESCRIPTION OF THE DRAWINGS

FIG. 1 is a diagram of a wireless sensor network according to the invention;

FIG. 2 is a block diagram of a distribute frame structure used with the network of FIG. 1; and

FIG. 3 is a flow diagram of a procedure for determining the frame structure of FIG. 2.

### DETAILED DESCRIPTION OF THE PREFERRED EMBODIMENT

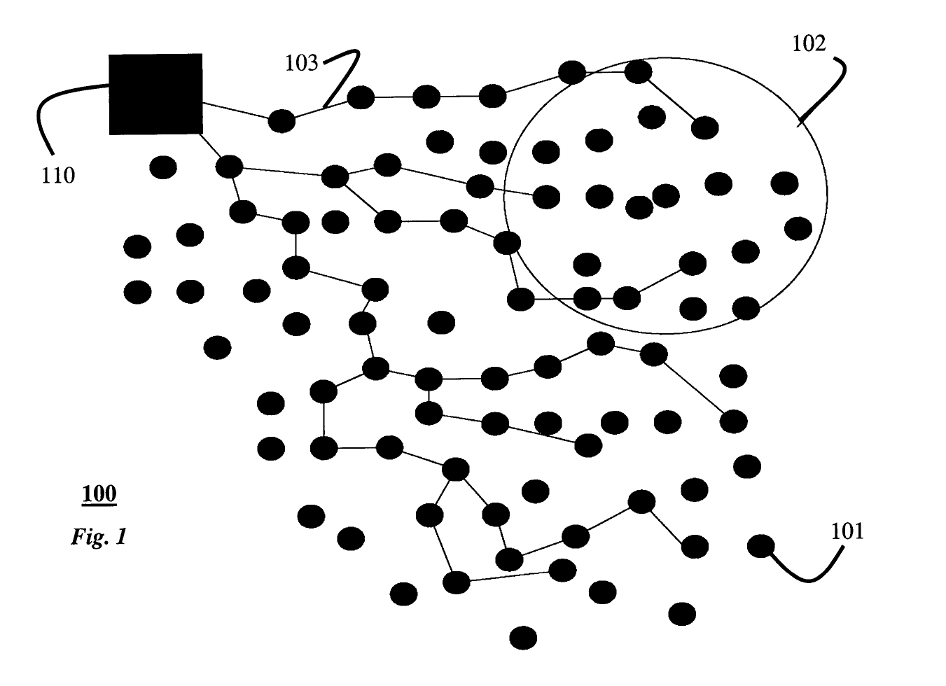

FIG. 1 shows a high-density wireless sensor network (WSN) 100 according to the invention. The WSN 100 includes numerous sensor nodes 101, and a centralized processing node 110. Nodes have a limited transmission range 102. Therefore, it is necessary for remote nodes to transmit data to the processing node 110 via paths 103 through intermediate nodes and a single shared wireless communication channel. The network can be static or ad-hoc. In addition, the network 100 can operate without an infrastructure, and is self-configurable.

The nodes can acquire environmental data such as temperature, pressure or air quality. In one embodiment, the data are transmitted periodically in fixed sized packets. In another embodiment, the data is event-based.

Protocol Overview

With distributed access to the shared channel, the protocol according to the invention provides reliable communication. Nodes contend for the channel whenever they have a packet to send. Because each node has to contend for the channel each time a packet is transmitted, scarce energy resources are consumed. Therefore, it is desired to maximize the likelihood of success during the contention period.

As the node density increases, more and more energy can be consumed as a result of increased collisions. In a prior art contention-based protocol, as a result of the contention, the nodes maintain coordination among themselves. This coordination can be thought as a schedule formed implicitly. However the information about this implicit schedule is not stored in the nodes. Hence, each node has to go through the same process each time it has a packet to send.

For those applications, which usually generate periodical traffics, this schedule can be preserved in each node to provide collision-free communication in the future attempts.

Although prior art TDMA-based solutions are based on this principle, the requirement of an infrastructure and local communication managers introduce increasing difficulties in terms of clustering and energy consumption.

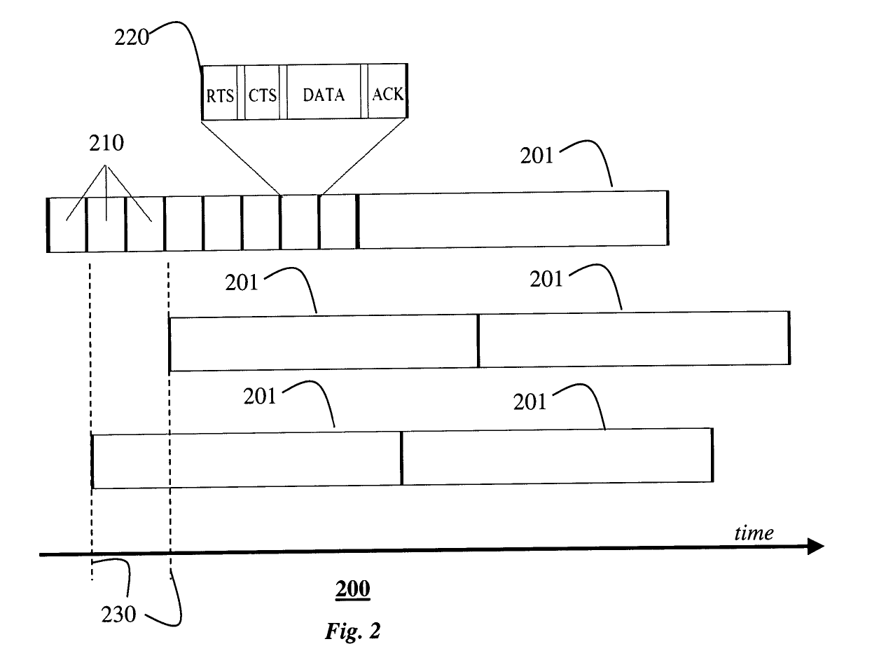

As shown in FIG. 2, we use a distributed frame structure 200. This structure addresses the distributed scheduling problem in wireless sensor networks, Each node in the network maintains a frame 201. The frame is based on the information acquired from the shared channel. Each node determines the available slots 210 in its frame 201 by passively monitoring the channel and selecting a time interval for transmission. It is sufficient to detect a carrier signal to detect channel occupancy during a slot. In a more complex implementation, nodes can decode packets to associate nodes with slots. Then, each node transmits using the same time interval in every frame and is inactive or ‘sleeps’ during other time intervals when the node is not transmitting or receiving packets. The size of the frame, and the number of available slots in each frame can depend on the available bandwidth and the packet size.

The transmission is based on an RTS/CTS/DATA/ACK scheme 220 of the IEEE 802.11b standard. The nodes perform backoff when multiple nodes select the same available time interval, and change their slots accordingly. Because the scheduling is based on the channel traffic, the DFB-MAC protocol minimizes collisions. Moreover, our DFB-MAC protocol does not require nodes to be synchronized at the MAC-level, i.e., each frame is maintained in a distributed manner. Hence, no signaling packets need to be transmitted, and no infrastructure is required.

However, we assume that neighboring nodes within the same transmission region are time synchronized 230 at the slot level to ensure proper communication between nodes. This requirement can be achieved for a WSN with a low data rate channel using existing protocols, e.g., see Elson et al., “Time synchronization for wireless sensor networks,” Proc. International Parallel and Distributed Processing, Symposium, pp. 1965-1970, April 2001, Elson et al., “Wireless sensor networks: A new regime for time synchronization,” Proc. First Workshop on Hot Topics In Networks, October 2002, and Wang et al., “A wireless time-synchronized COTS sensor platform, Part II: applications to beamforming,” Proc. IEEE CAS Workshop

As shown in FIG. 2, each node maintains a frame 201. The frame is partitioned into time intervals 210. A duration of each time interval matches the transmission time for a fixed size packet. The number of slots, i.e., a frame size, can also be determined according to density and traffic properties of the network 100.

Distributed Frame-Based MAC Protocol

A node transmitting packets maintains a schedule of time intervals within its frame structure. Frames of different nodes do not need to be synchronized, although the slots within frames are. That is, the start and end of each frame at different nodes can be different from each other, as shown. A node acquires channel occupancy information by monitoring the shared channel. Then, the node schedules its packets during available time intervals accordingly. The monitoring can also reveal an identity of nodes that are part of the network.

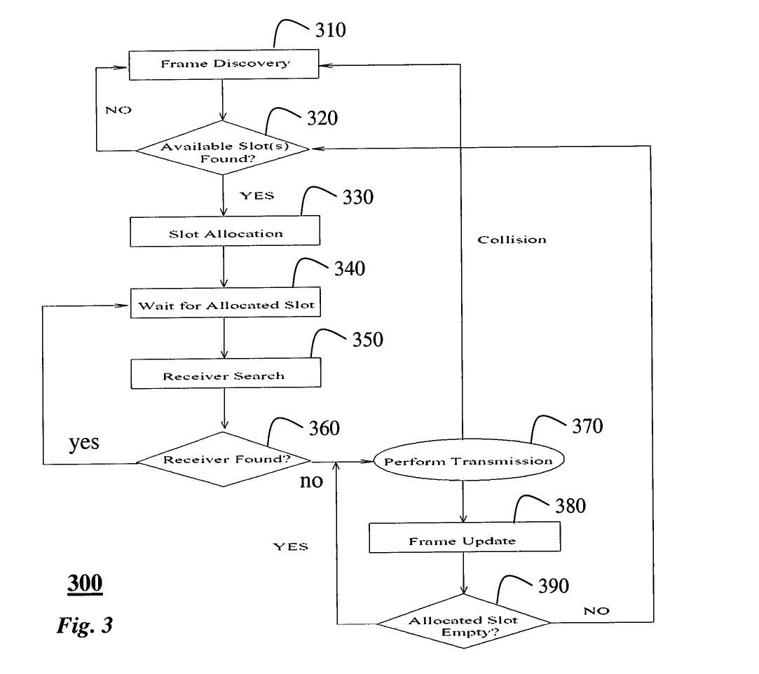

FIG. 3 shows the detailed steps 300 of the protocol.

Frame Discovery 310:

Each node passively monitors the channel for a predetermined amount of time, which is at least as long as one frame 102.

According to the signal in the channel, e.g., a carrier signal, the node marks time intervals as available or occupied. Nodes can transmit packets for a time slot marked as available. Thus, available time slots can be determined 320. As a result, the transmission frame 201 is constructed based on the information available in the shared channel.

Slot Allocation 330:

After the transmission frame is constructed, the node allocates a transmission slot among the available slots in the transmission frame 201. The selection can be random or in some predetermined order. If the frame is large, it may be possible to allocate multiple slots to a node. Because the transmission frame is constructed based on the channel traffic, there is a high probability that the communications of the node do not collide with communications of other nodes. In order to further prevent collisions with possible new joining nodes, the node performs four way handshaking 220 based on the IEEE 802.11 RTS/CTS/DATA/ACK scheme.

Each nodes ‘sleeps’ when it is not transmitting or receiving data, or otherwise waiting 340 for an allocated slot.

Receiver Search 350:

Nodes perform receiver search, until a receiver is found 360, to indicate their receivers about their intention to transmit data. After selecting a slot for transmission, a node can continuously transmits 370 RTS packets during that slot in each frame so that other nodes can construct and update their frames appropriately.

After the receiver performs a frame update 380, as described below, transmission can be performed 370.

Frame Update 380:

Due to the dynamic nature of the sensor networks, the time slot scheduling in the frame of each node can change over time. In order to update 380 the transmission frame structure, each node performs frame discovery phase in a specified period. Depending on the traffic changes, transmission frame is updated to ensure that an allocated slot remains available 390. In addition, each node searches for a potential transmitter performing receiver search.

### EFFECT OF THE INVENTION

The invention provides a distributed frame-based medium access control protocol for a wireless sensor network. The protocol is efficient, and minimizes energy consumption and latency. In the protocol, each node determines and maintains a transmission schedule for itself independent of other nodes. Therefore, the protocol does not require clustering or some other type of infrastructure.

Experiments show that the DFB-MAC protocol according to the invention has better performance, in terms of energy efficiency and throughput, than the conventional IEEE 802.11 protocol, which is also a distributed MAC protocol.

The DFB-MAC protocol provides efficiency increase up to 100% when compared to the protocol based on the IEEE 802.11 standard. The energy consumption of the protocol is two orders of magnitude lower than the one based on IEEE 802.11. Thus, the invention achieves both throughput gain and energy saving by distributively coordinating the scheduling of transmissions of sensor nodes, so that scarce resources are consumed efficiently. DFB-MAC also achieves comparable latency to the IEEE 802.11, which makes the protocol suitable for applications where latency is not a constraint.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A media access control protocol for a network including a plurality of nodes connected to each by a single shared wireless communications channel, the protocol for each node comprising:
monitoring, in each node, the channel for a period of time equal to at least a length of a frame;
partitioning the frame into a plurality of time slots;
marking a particular time slot as occupied if the channel has a carrier signal during the time slot and otherwise marking the time slot as available;
transmitting a packet only if the time slot is marked available.

2. The method of claim 1, in which the nodes are sensor nodes.

3. The method of claim 1, in which the network is ad-hoc.

4. The method of claim 1, in which the packet is transmitted periodically.

5. The method of claim 2, in which the packet is transmitted in response to a sensed event.

6. The method of claim 1, in which the time slots of the frames of the nodes are time synchronized.

7. The method of claim 1, in the channel is monitored and the marking of the time slots are updated periodically.

8. The method of claim 1, in which the monitoring is passive.

9. The method of claim 1, in which the marking only requires information acquired by monitoring the channel.

10. The method of claim 1, in which different nodes transmit packets at different rates.

11. The method of claim 1, in which the monitoring reveals identities of the plurality of nodes in the network.
